(19) United States
(12) Patent Application Publication
(10) Pub. No.: US 2016/0023500 A1
(43) Pub. Date: Jan. 28, 2016

(54) PEN CAP

(71) Applicant: Huang-Lin Wang, Kaohsiung City (TW)

(72) Inventor: Huang-Lin Wang, Kaohsiung City (TW)

(21) Appl. No.: 14/560,302

(22) Filed: Dec. 4, 2014

(30) Foreign Application Priority Data
Jul. 24, 2014 (TW) 103125322

(51) Int. Cl. B43K 23/04; B43K 23/12; B43K 23/00

(52) U.S. Cl. CPC B43K 23/04; B43K 23/001; B43K 23/12

(57) ABSTRACT

The pen cap comprises a cap unit and an adhering unit formed on the cap unit. The cap unit comprises a top wall, a side wall, a bottom wall, and a groove. The top wall, the side wall, and the bottom wall are integrated and the side wall is located between the top wall and the bottom wall. The groove is inwardly formed on the top wall. A front end of a pen is inserted in to the groove. The pen cap can attach to a surface for insertion of the pen and make the pen stand on the surface to reduce the surface area occupied by the pen. With the adhering unit, the pen cap can firmly attach to a vertical surface or a horizontal surface to prevent the pen from rolling or sliding to ground and from being broken or lost.

### CROSS-REFERENCE TO RELATED APPLICATIONS

The present application claims priority from Taiwan Patent Application No. 103125322 filed Jul. 24, 2014, the disclosure of which is hereby incorporated herein by reference.

### BACKGROUND OF THE INVENTION

1. Field of the Invention

The present invention relates to a pen cap, especially to a pen cap with an adhering unit.

2. Description of Related Art

When not in use, a pen usually is disposed flatly on a horizontal plane, but the pen disposed in this manner occupies more space of the horizontal plane. Besides, if the pen is touched or the horizontal plane is shaken, the pen tends to roll or slide to the ground such that the pen is broken or lost. Furthermore, the pen cannot be put on a vertical plane such as a wall or a white board. Improvement on versatility of the pen is needed.

A conventional pen holder can be put on a table or desk for insertion of the pen. However, in order to ensure the stability of the pen holder when put on the table or desk, the pen holder usually has a large bottom area such that the pen holder still occupies large space on the table or desk and is inconvenient to carry around.

Furthermore, if the pen holder is touched or falls down due to shaking of the table or desk, the pen holder will also slide to the ground such that the pen inserted in the pen holder is broken or lost.

To overcome the shortcomings, the present invention provides a pen cap to mitigate or obviate the aforementioned problems.

### BRIEF SUMMARY OF THE INVENTION

The objective of the present invention is to provide a pen cap which can prevent sliding or falling of a pen and facilitate ease in portability.

The pen cap comprises a cap unit and an adhering unit formed on the cap unit.

The cap unit comprises a top wall, a side wall, a bottom wall, and a groove. The top wall, the side wall, and the bottom wall are integrated and the side wall is located between the top wall and the bottom wall. The groove is inwardly formed on the top wall. A front end of a pen is inserted in to the groove.

Preferably, the adhering unit comprises a first magnet. The first magnet is vertically mounted in the side wall and is located next to the groove.

Preferably, the adhering unit comprises a second magnet. The second magnet is horizontally mounted in the bottom wall and is located under the groove. The pen cap can attach to a magnetic surface by the first magnet or the second magnet, thereby improving the versatility of the pen cap.

Preferably, the cap unit is made of elastomer and the adhering unit comprises a concavity inwardly formed from the bottom wall. Inasmuch the cap unit is made of elastomer such as rubber, silicone, or plastic, the cap unit is elastic; therefore the concavity can act like a sucker to attach on a placement surface so as to prevent the pen from rolling or sliding and from falling to ground.

Preferably, the adhering unit comprises an adhering element. The adhering element is mounted to the concavity.

Preferably, a conductive layer is coated on a surface of the cap unit.

Preferably, the cap unit is made from an elastomer material having multiple conductive particles.

Preferably, the cap unit comprises a clip element having a connecting end and a free end. The connecting end is mounted to the bottom wall and the free end is located next to the side wall.

Preferably, the cap unit comprises a connecting element having a fixing portion and a connecting portion. The fixing portion is mounted to the side wall of the cap unit and the connecting portion is opposite to the fixing portion.

The pen cap in accordance with the present invention can attach to a surface for insertion of the pen and make the pen stand on the surface, such as a white board or a wall, to reduce the surface area that the pen occupies. With the adhering unit, the pen cap can firmly attach to a vertical surface or a horizontal surface to prevent the pen from rolling or sliding to ground and from being broken or lost.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a pen cap in Embodiment 1 in accordance with the present invention;

FIG. 2 is a perspective view of the pen cap in FIG. 1;

FIG. 3 is an operational view of the pen cap in FIG. 1 holding a pen;

FIG. 4 is another operational view of the pen cap in FIG. 1 holding a pen;

FIG. 5 is a side view of a pen cap in Embodiment 2 in accordance with the present invention;

FIG. 6 is a side view of a pen cap in Embodiment 3 in accordance with the present invention;

FIG. 7 is a side view of a pen cap in Embodiment 4 in accordance with the present invention;

FIG. 8 is a side view of a pen cap in Embodiment 5 in accordance with the present invention; and

FIG. 9 is an operational view of a pen cap in Embodiment 6 in accordance with the present invention.

### DETAILED DESCRIPTION OF THE PREFERRED EMBODIMENTS

### Embodiment 1

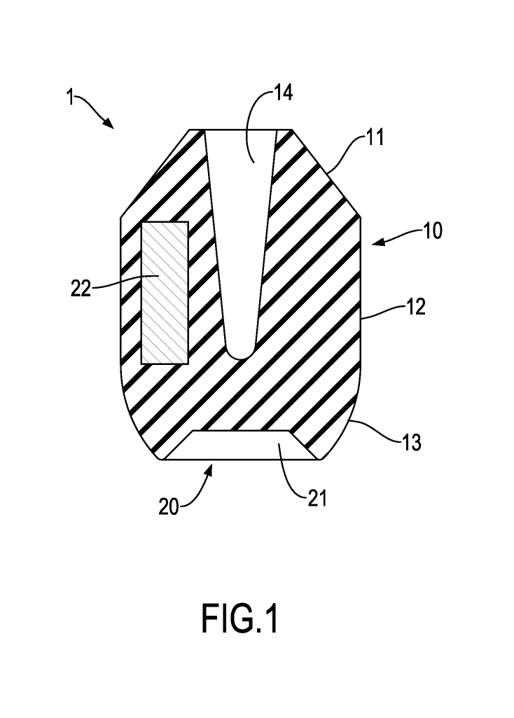

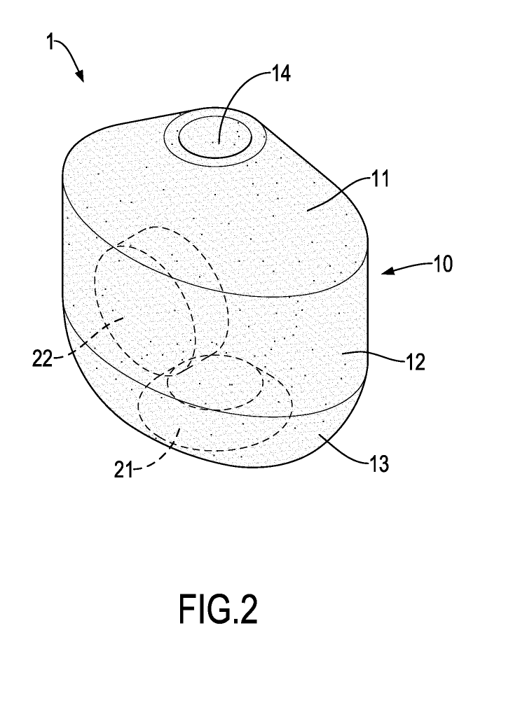

With reference to FIG. 1 and FIG. 2, a pen cap 1 in accordance with the present invention comprises a cap unit 10 and an adhering unit 20.

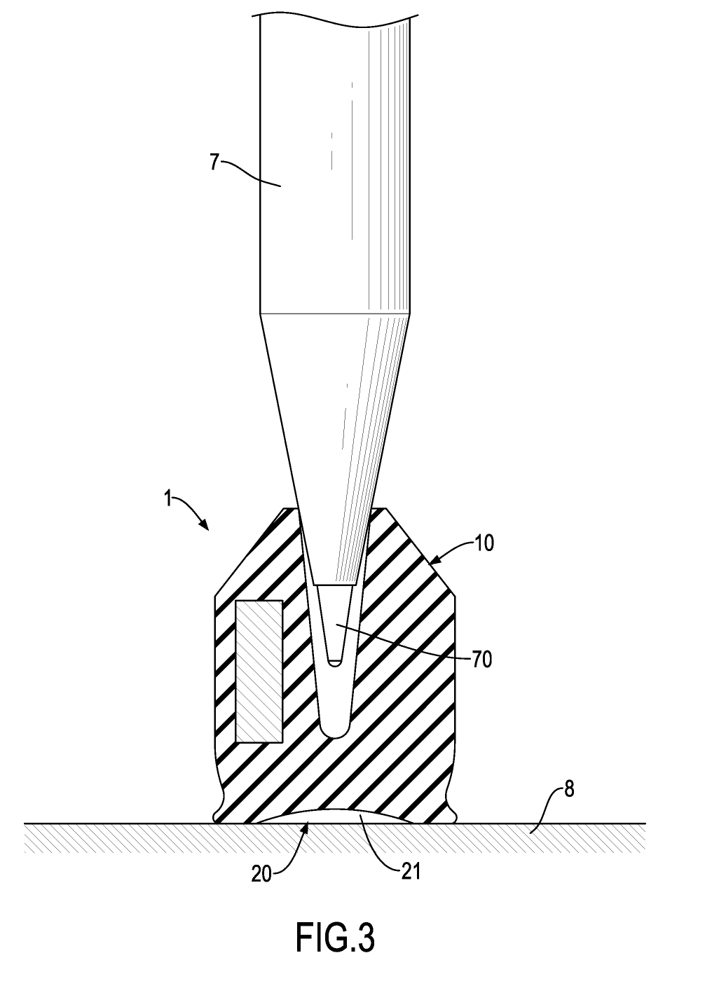

The cap unit 10 is made of rubber and comprises a top wall 11, a side wall 12, a bottom wall 13, and a groove 14. The top wall 11, the side wall 12, and the bottom wall 13 are integrated. The side wall 12 is located between the top wall 11 and the bottom wall 13. The pen cap 1 can stand on a plane by the bottom wall 13. The groove 14 is inwardly formed on the top wall 11. With reference to FIG. 3, a front end 70 of a pen 7 can be inserted into the groove 14.

The adhering unit 20 is mounted to the cap unit 10. The adhering unit 20 comprises a concavity 21 and a first magnet 22. The concavity 21 is inwardly formed from the bottom wall 13. The first magnet 22 is vertically mounted in the side wall 12 and is located next to the groove 14.

With reference to FIG. 3, the cap unit 10 is made of rubber and is elastic; therefore, the concavity of the adhering unit 20, acting like a sucker, can attach to a placement surface 8 to prevent the pen 7 from rolling or sliding and falling to the ground. The placement surface 8 is not limited in a horizontal plane.

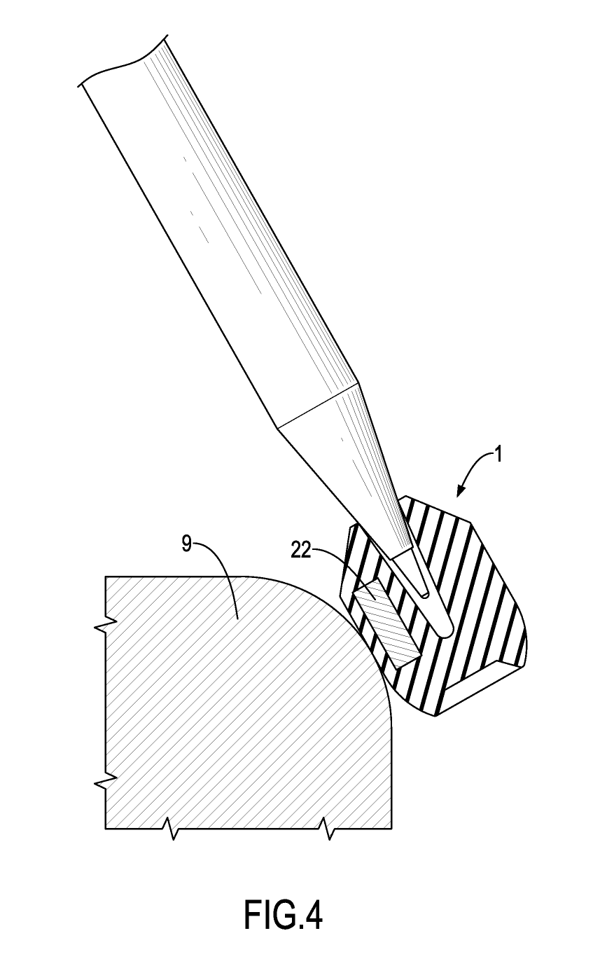

With reference to FIG. 4, the pen cap 1 can also magnetically attach to a magnetic surface 9 by the first magnet 22 which broadens the options for placing the pen 7.

### Embodiment 2

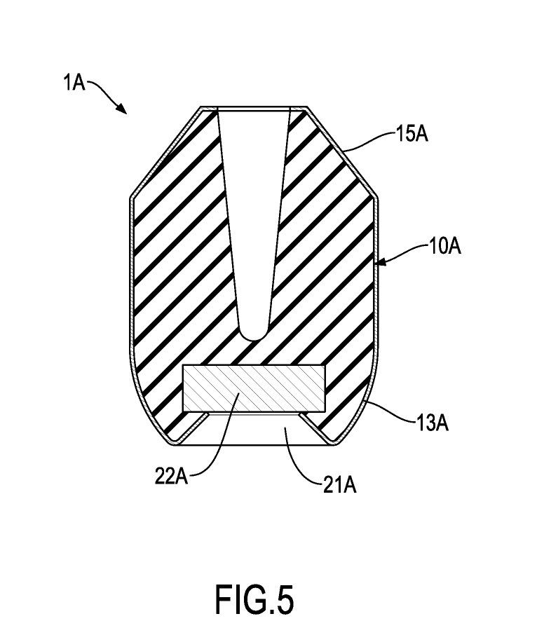

With reference to FIG. 5, the pen cap 1A in Embodiment 2 is similar to the pen cap 1 in Embodiment 1. The difference between the two embodiments is that the pen cap 1A further comprises a conductive layer 15A. The conductive layer 15A is coated on a surface of the cap unit 10A such that the surface of the cap unit 10A is electrically conductive. When a pen is inserted into the pen cap 1A (not show in FIG. 5), the pen acts as a stylus. The cap unit 10A is made of silicone. The first magnet 22A is horizontally mounted in the bottom wall 13A. The first magnet 22A is located under the groove 14A and is parallel to the concavity 21A. Strength of attachment between a magnetic surface and the pen cap 1A can be improved because the first magnetic 22A and the concavity 21A are parallel; hence the bottom wall 13A of the cap unit 10A can magnetically attach to the magnetic surface more firmly.

### Embodiment 3

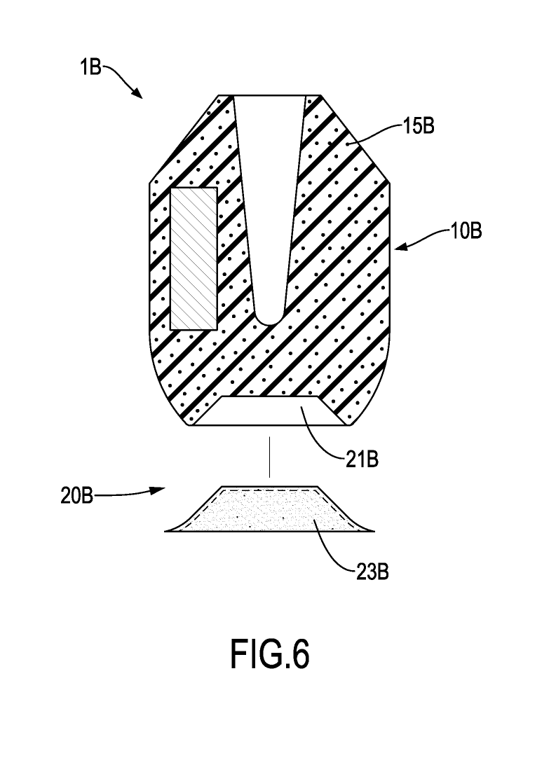

With reference to FIG. 6, the pen cap 1B in Embodiment 3 is similar to the pen cap 1 in Embodiment 1. The difference between the two embodiments is that the adhering unit 20B further comprises an adhering element 23B. The adhering element 23B is mounted to the concavity 21B and is a sucker. The pen cap 1B can attach to a surface by the adhering element 23B; therefore the material of the cap unit 10B is not limited to elastomer such as rubber but has increased options in design. The cap unit 10B has a plurality of conductive particles 15B to make the cap unit 10B electrically conductive. When a pen is inserted into the pen cap 1B (not show in FIG. 6), the pen acts as a stylus.

### Embodiment 4

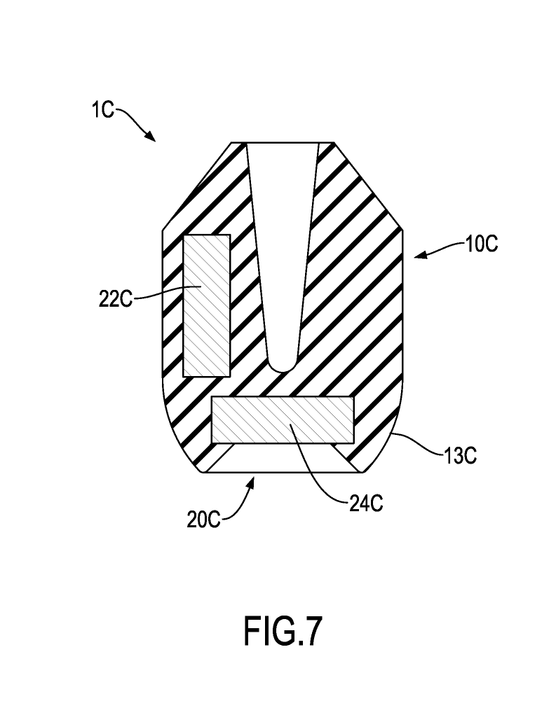

With reference to FIG. 7, the pen cap 1C in Embodiment 4 is similar to the pen cap 1 in Embodiment 1. The difference between the two embodiments is that the cap unit 10C is made of plastic. The adhering unit 20C further comprises a second magnet 24C. The second magnet 24C is horizontally mounted in the bottom wall 13C. The second magnet 24C is located under the groove 14C and is parallel to the concavity 21C. With the first magnet 22C, the second magnet 24C, and the concavity 21C, both the bottom surface and the side surface can attach to a magnetic surface, which expands the versatility of the pen cap 1C.

### Embodiment 5

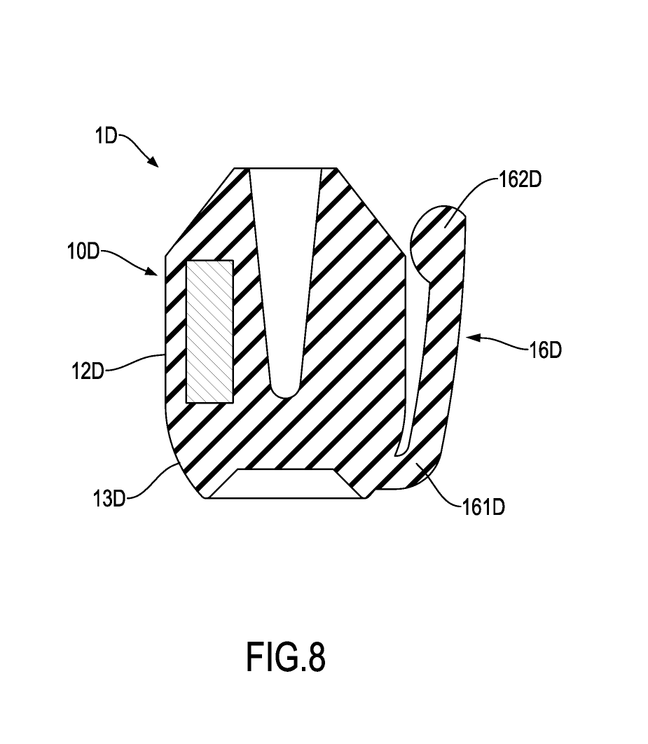

With reference to FIG. 8, the pen cap 1D in Embodiment 5 is similar to the pen cap 1 in Embodiment 1. The difference between the two embodiments is that the cap unit 10D further comprises a clip element 16D. The clip element 16D has a connecting end 161D and a free end 162D. The connecting end 161D is mounted to the bottom wall 13D. The free end 162D is located next to the side wall 12D. The free end 162D cooperates with the side wall 12D to clip a sheet-shaped article (not show in FIG. 8).

### Embodiment 6

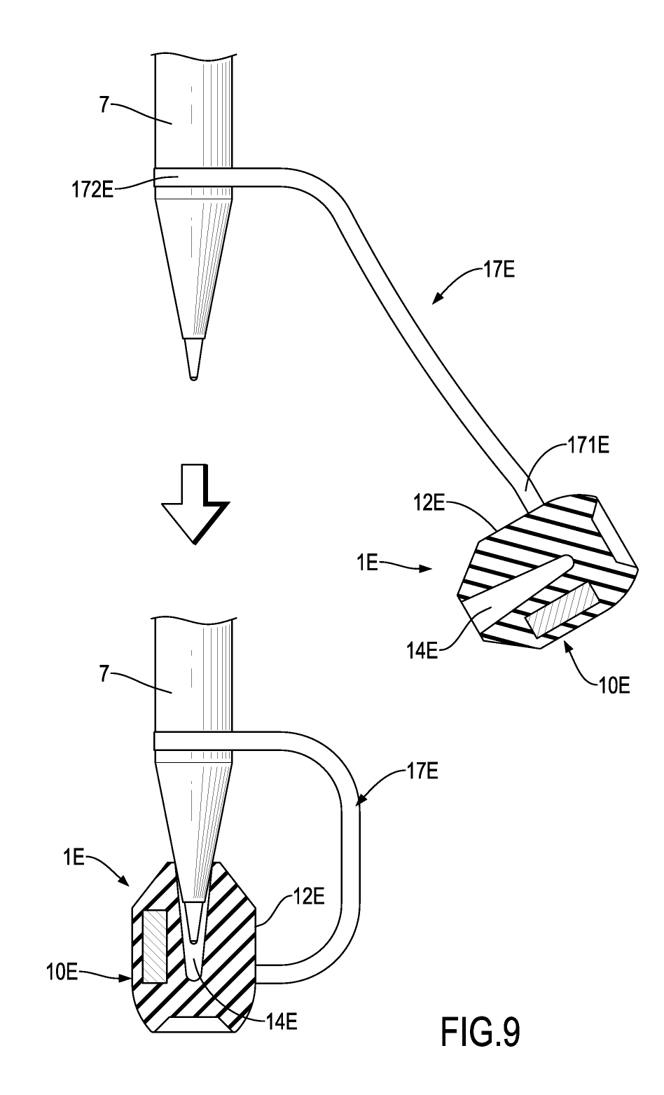

With reference to FIG. 9, the pen cap 1E in Embodiment 6 is similar to the pen cap 1 in Embodiment 1. The difference between the two embodiments is that the cap unit 10E further comprises a connecting element 17E. The connecting element 17E has a fixing portion 171E and a connecting portion 172E. The fixing portion 171E is mounted to the side wall 12E of the cap unit 10E. The connecting portion 172E is opposite to the fixing portion 171E and selectively covers a front end of a pen 7. The pen 7 and the pen cap 1E are connected by the connecting element 17E; therefore, even when the front end of the pen 7 is drawn out from the groove 14E of the cap unit 10E, the cap unit 10E is still connected to the pen 7 and thus will not be lost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A pen cap comprising:
a cap unit comprising
a top wall;
a side wall;
a bottom wall;
wherein the top wall, the side wall, and the bottom wall are integrated and the side wall is located between the top wall and the bottom wall; and
a groove inwardly formed on the top wall; and
an adhering unit mounted on the cap unit.

2. The pen cap as claimed in claim 1, wherein the adhering unit comprises a first magnet, the first magnet is vertically mounted in the side wall and is located next to the groove.

3. The pen cap as claimed in claim 1, wherein the adhering unit comprises a second magnet, the second magnet is horizontally mounted in the bottom wall and is located under the groove.

4. The pen cap as claimed in claim 2, wherein the adhering unit comprises a second magnet, the second magnet is horizontally mounted in the bottom wall and is located under the groove.

5. The pen cap as claimed in claim 1, wherein the cap unit is made of elastomer and the adhering unit comprises a concavity inwardly formed from the bottom wall.

6. The pen cap as claimed in claim 5, wherein the adhering unit comprises an adhering element, the adhering element is mounted to the concavity.

7. The pen cap as claimed in claim 1, wherein the cap unit is made of elastomer and a conductive layer is coated on a surface of the cap unit.

8. The pen cap as claimed in claim 1, wherein the cap unit is made of an elastomer material having multiple conductive particles.

9. The pen cap as claimed in claim 1, wherein the cap unit comprises a clip element having a connecting end and a free end, the connecting end of the clip element is mounted to the bottom wall, and the free end of the clip element is located next to the side wall of the cap unit.

10. The pen cap as claimed in claim 1, wherein the cap unit comprises a connecting element having a fixing portion and a connecting portion, the fixing portion of the connecting element is mounted to the side wall of the cap unit and the connecting portion of the connecting element is opposite to the fixing portion of the connecting element.
